(19) United States
(12) Patent Application Publication
(10) Pub. No.: US 2012/0185402 A1
(43) Pub. Date: Jul. 19, 2012

(54) ONLINE RECRUITMENT SYSTEM AND METHOD

(75) Inventor: Stephane Lajoie, Alma (CA)

(73) Assignee: IPAXIO S.E.N.C., Quebec (CA)

(21) Appl. No.: 13/497,165

(22) PCT Filed: Sep. 24, 2010
(86) PCT No.: PCT/CA10/01485

§ 371 Date: Mar. 20, 2012

Related U.S. Application Data
(60) Provisional application No. 61/272,459, filed on Sep. 25, 2009.

(51) Int. Cl. G06Q 10/06

(52) U.S. Cl. 705/321

(57) ABSTRACT

The system and method allows finding candidates for job offers using a reward scheme, in which members of the public provide contact information on one or more potential candidates for available job offers. Considering that most employment opportunities are communicated by acquaintances, available job offers are presented as “wanted notices”, with an attached reward to encourage members of the public to participate in an employee search for filling one or more available job positions. These participants become “third-party submitters” and only need to provide contact information required for the system to send an invitation message to the corresponding potential candidate. The potential candidate does not need to be registered or otherwise known by the system beforehand. Ultimately, when a candidate is hired by a hiring entity, the corresponding third-party submitter receives at least a portion of the associated reward.

### TECHNICAL FIELD

The technical field relates to an online recruitment system and method.

### BACKGROUND

Whenever an employer has a job position to fill, the challenge is always to attract the attention of the best candidates. Many different ways of advertizing job offers exist. For instance, job offers can be published in newspapers or on job searching and placement web sites to name just a few. Some job positions, however, are harder to fill than others. This may be the case of job positions requiring specific education, training, skills, experience and/or aptitudes. Other available job positions may be difficult to fill because of a great demand from other employers for the same category of employees. Many other situations also exist.

Oftentimes, the best candidates for available job positions may include people that are already employed and that are not currently searching for a new job or career at that point in time. These persons may nevertheless be potentially interested in new employment opportunities if they ever hear about them. This is what can be called the “hidden market of employment”, by contrast to the “active market of employment” in which people actively search for a job or for a new job.

One traditional way of finding people, especially within the hidden market of employment, is to hire a recruitment specialist. Recruitment specialists, also sometimes called “head hunters”, generally fulfill mandates of finding suitable candidates for available job positions and are paid when one of their candidates is hired. Recruitment specialists often have very large networks of contacts and can also make cold calls to people they do not necessarily know already to broaden their search. However, even with a large network and good leads, finding good candidates always remains a challenge for recruitment specialists. Still, using recruitment specialists may not always be suitable or even possible for some available job positions.

Also, some candidate management systems and methods have been proposed over the years. For instance, U.S. Pat. No. 6,457,005, granted on 24 Sep. 2002 to David R. Torrey, discloses a method and system for referral management. The solicitation and management of referrals includes methods that record in a database the descriptions of opportunities and the terms under which referral fees will be paid to parties that refer resources for consideration. In one application, opportunities are employment openings and resources are potential employees. Parties may search the database to discover opportunities along with the related referral-fee information, and may submit a referral that includes information describing a resource for consideration to satisfy an opportunity described in the database. A subsequent trigger event, such as a referred person being hired, initiates activities that allow a referring party to receive the referral fees that are due under the terms that are recorded in the database.

US published patent application No. 2006/0212305 A1, published on 21 Sep. 2006 to Philip Lee Bogle et al., discloses a method and apparatus for ranking candidates using connection information provided by candidates. The method and apparatus are provided to permit candidates to connect with a company so as to enhance their potential ranking. Preferably, the method includes steps of and/or the apparatus performs steps of assisting candidates to contact employees of a company, either directly or via non-employee referrals, to obtain referrals to the company. Based upon such referrals, the method may further include receiving candidate referrals from a plurality of referrers, generating a predicted prospect ranking (PPR) based at least in part on received candidate referrals, and displaying a candidate list ranked by the PPR.

Existing systems and methods have inherent limitations and are not always suitable in some situations. Accordingly, room for improvements still exists in this area.

### SUMMARY

Generally stated, the proposed concept allows finding candidates for job offers using a reward scheme, in which members of the public provide contact information on one or more potential candidates for available job offers. Considering that most employment opportunities are communicated by acquaintances, the present concept proposes to convert available job offers into “wanted notices”, with an attached reward to encourage members of the public to participate in an employee search for filling one or more available job positions. These participants become “third-party submitters” and only need to provide contact information required for the system to send an invitation message to the corresponding potential candidate. The potential candidate does not need to be registered or otherwise known by the system beforehand. Ultimately, when a candidate is hired by a hiring entity, the corresponding third-party submitter receives at least a portion of the associated reward.

In one aspect, there is provided an on-line recruitment system including: a processor; a memory operatively connected to the processor, the memory storing a program for directing the processor to: receive information concerning a job offer from an hiring entity, the job offer including a reward; receive contact information from third-party submitters concerning potential candidates that may be interested and qualified for filling the job offer; send individual electronic invitation messages to the potential candidates about the job offer and the corresponding third-party submitter that referred them, the invitation messages being sent to each potential candidate using the contact information received from the corresponding third-party submitter; receive a confirmation from the potential candidate that he/she is acquainted with the corresponding third-party submitter; upon receiving the confirmation from the potential candidate that he/she is acquainted with the corresponding third-party submitter, present information about the job offer to the potential candidate; upon receiving an indication from at least one of the potential candidates that he/she would like to apply for the job offer, upgrade the potential candidate to a confirmed candidate; calculate a performance indicia for each of the third-party submitters of the confirmed candidates and associate the performance indicia with the corresponding confirmed candidate, each performance indicia being based on objective data recorded by the system about past candidates submitted by the corresponding third-party submitter; and upon hiring one of the confirmed candidates, notify the corresponding third-party submitter that he/she has earned at least a portion of the reward.

In another aspect, there is provided a method for recruiting employees, the method including: receiving information concerning a job offer from a hiring entity the job offer including a reward; receiving contact information from third-party submitters concerning potential candidates that may be interested and qualified for filling the job offer; sending individual messages to the potential candidates about the job offer and the corresponding third-party submitter that referred them, the messages being sent to each potential candidate using the contact information received from the corresponding third-party submitter and including at least a request to confirm that the potential candidate is acquainted with the corresponding third-party submitter; receiving a confirmation from the potential candidate that he/she is acquainted with the corresponding third-party submitter; upon receiving the confirmation from the potential candidate that he/she is acquainted with the corresponding third-party submitter, presenting information about the job offer to the potential candidate; upon receiving a confirmation from at least one of the potential candidates that he/she would like to apply for the job offer, upgrading the potential candidate to a confirmed candidate; calculating a performance indicia for each of the third-party submitters of the confirmed candidates and associating the performance indicia with the corresponding confirmed candidate, each performance indicia being based on objective data recorded by the system about past candidates submitted by the corresponding third-party submitter and upon hiring one of the confirmed candidates, notifying the corresponding third-party submitter that he/she has earned at least a portion of the reward.

Further details on these aspects as well as other aspects of the proposed concept will be apparent from the following detailed description and the appended figures.

### BRIEF DESCRIPTION OF THE FIGURES

FIG. 1 is a schematic view illustrating an example of computing devices connected to an online recruitment system of the proposed concept using a data network;

FIG. 2 is a flow diagram illustrating an example an example of how a registered user accesses the system;

FIG. 3 is a flow diagram depicting an example of the interaction between a third-party submitter and the system;

FIG. 4 is a flow diagram illustrating an example of the interaction between a potential candidate and the system;

FIG. 5 is a flow diagram illustrating an example of the interaction between a potential candidate and the system when the potential candidate declines the job offer but wants to refer another potential candidate;

FIG. 6 is a flow diagram illustrating an example of what the system 10 can do after a potential candidate becomes a confirmed candidate;

FIG. 7 is a flow diagram illustrating an example of the interaction between a hiring entity and the system; and

FIGS. 8 to 13 are copies of the figures from the priority application, for reference proposes.

### DETAILED DESCRIPTION

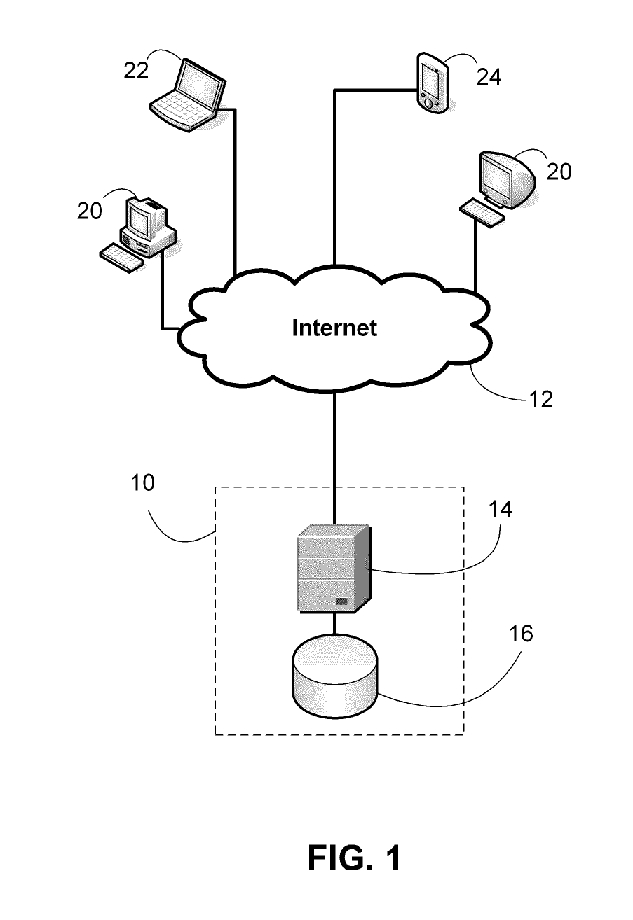

FIG. 1 is a schematic view illustrating an example of computing devices connected to an online recruitment system 10 of the proposed concept using a data network 12, for instance the Internet. It should be noted that although references are made to the Internet as the data network 12 for the purpose of illustration and in the following description, the proposed concept is not limited for use with the Internet. For instance, the data network 12 can be a local area network (LAN) or a wide area network (WAN) that does not necessarily include the Internet. Other configurations and arrangements are also possible.

As shown in FIG. 1, the system 10 includes a management server 14 connected to at least one database 16. The server 14 includes a processor and a memory operatively connected to the processor. The memory stores a program for directing the processor to perform various tasks.

It should be noted that the system 10 can also be implemented using more than one server sharing various tasks and/or for providing a redundancy scheme in case of a failure of one or more of these servers. For instance, one can use a web server for web-related tasks and another server for other tasks. The reference in the present description to a single server 14 does not exclude using a plurality of servers. The same comment also applies to the number of processors, memories and/or databases. Reference will be made in the present description to a single processor, memory and database but using more than one of each is not excluded.

In the present example, there are four different types of basic users for the system 10, namely the “hiring entities”, the “third-party submitters”, the “candidates” and the “unregistered users”.

A “hiring entity” can be broadly defined as either an employer or someone working for employer. For instance, an employer may delegate a portion of the hiring process to a recruitment specialist or firm. A single hiring entity may actually include more than one person or firm. For instance, the overall process can be managed by a team. Their main goal is to fill an available job position with the best qualified candidate interested in this employment opportunity.

A hiring entity uses the system 10 to present what is referred to hereafter as a “job offer”. The system 10 will use information entered into the system by a hiring entity to generate an online job offer. An online job offer can be broadly defined as a notice that a job offer exists and that a “reward” is associate with it. The reward can be a monetary reward or any other kind of reward that may prompt someone to suggest a potential candidate in response to a job offer available through the system 10. Examples of non-monetary rewards can include tickets for sports events, promotional items, substantial discounts on some goods or services, etc. Many other examples can be found as well. The job offers can be displayed on the system 10 itself but can also be made available elsewhere than the system 10. For instance, it be made available on other web sites as part of their content or as advertisements with hyperlinks to the corresponding system's web page. Other approaches are also possible. Job offers can be presented in the form of a listing and/or be searchable using a search engine built-in into the system 10.

It should be noted that although the present description presents a job offer as a single job position, using the system for presenting a single job offer for many available job positions is not excluded. For instance, a hiring entity may be looking to hire many qualified candidates that will have substantially the same job description. Likewise, the work “job” must be understood in a broad sense. For instance, it also applies to a training position where the person “hired” may not necessarily receive a salary.

A “third-party submitter” can be broadly defined as a member of the public or of a very large group of people. That person has a network of contacts and is able to make a connection between an available job offer presented in a job offer posting in the system and someone that the person knows. The third-party submitter then notifies the system 10 that he/she knows someone that may be interested and qualified for filling the job offer.

It should be noted that the word “public” can mean the general public or a subgroup of the general public. For instance, members of a large national association can be considered as members of the public. The system 10, however, should be opened to a maximum number of persons so as to maximize the chances of finding suitable candidates for the available job positions. Notwithstanding the above, it should be noted that it is not excluded that a third-party submitter be in fact a company or a group (or pool) of persons and/or firms. Reference will be made in the present description to a single natural person but the other possibilities are not excluded. On the other hand, it must be understood that a third-party submitter for an available job offer is never the hiring entity for that job offer. Likewise, a third-party submitter is not someone submitting his/her own name as a potential candidate.

A “candidate” is a person that was first identified as a potential candidate by a third-party submitter for an available job offer through the system 10. As aforesaid, the potential candidate does not need to be registered or otherwise known by the system 10 beforehand. Unlike existing recruitment systems, the candidate can only progress through the various levels of the selection process if the potential candidate provides certain information to the system 10. The third-party submitter does not supply all the information for the candidate to be hired. This will be explained in further details.

It should be noted that one or more potential candidates can become themselves third-party submitters for the same job offer for which someone thought they could be interested in and qualified for. That could happen if, for example, the potential candidate is not interested in or qualified for the job offer after reading information about it but that person knows someone else that might be. Other situations do exist as well.

An “unregistered user” can be a member of the public accessing an unrestricted web page or pages displaying information about available job offers and the reward associated with each of them. While some information may be restricted to registered users, the system 10 can provide extensive information for maximizing the chances of having an unregistered user becoming a third-party submitter submitting information on one or more potential candidates. It should be noted that a registered user can choose to access the system 10 as an unregistered user for one reason or another. For instance, someone already registered as a third-party submitter may access the system 10 as an unregistered user to overview new job offers or for some other reasons.

The system 10 can be designed to provide a wide range of functionalities to even unregistered users, such as search engines with advanced searching capabilities.

Referring to FIG. 1, any one of the users can communicate with the system 10 using computing devices such as personal computers 20, laptop computers 22, personal assistant devices 24 or any other suitable devices on which may run a user interface in the form of a communication software such as, for example, a web browser or the like. The interface can also include a dedicated program running on some or all of the computing devices. The computing devices are linked to the server 14 using the data network 12.

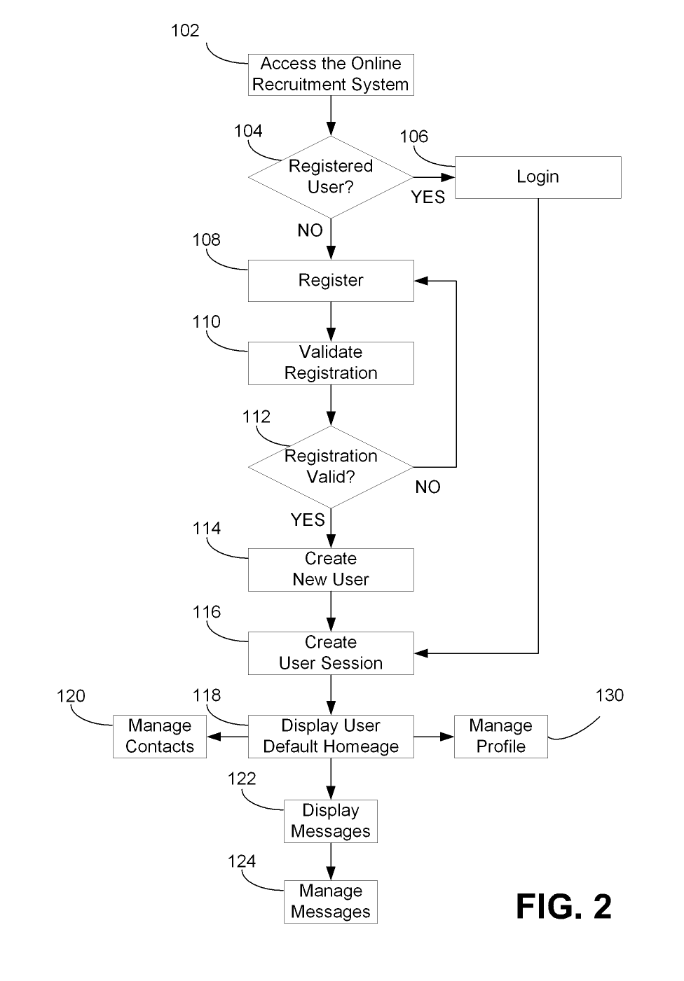

FIG. 2 is a flow diagram illustrating an example of how a registered user accesses the system 10. It also shows how an unregistered user can become a registered user. A user, regardless if he or she is already a registered user or not, accesses the system 10 at block 102.

At block 104, the system 10 verifies if the user is a registered user. If so, it proceeds to block 106 where the user logs in and then proceeds to block 116, otherwise it proceeds to block 108.

At block 108, the system 10 prompts the unregistered user to register. The user enters personal information, chooses a unique username and password. The system 10 can also ask if the user should be considered by default as a hiring entity, a third-party submitter or a candidate. The system 10 then validates, at block 110, the new user's information. For instance, it can check the uniqueness of username, if the user is already known by the system 10, etc.

At block 112, the system 10 verifies if the new user's registration is valid. If so, it proceeds to block 114, otherwise it can return back to block 108.

At block 114, the new user's information is stored into the database 16 (FIG. 1). If desired, a confirmation message, for instance an email, can be sent to the new user for confirming the registration.

At block 116, the system 10 creates a new user session and, at block 118, displays the user's default homepage. From there, the user may also manage contacts at block 120, display messages at block 122 and manage a personal profile at block 130. Further to displaying its messages, the user may also manage messages at block 124.

It is to be understood that additional functionalities may be provided as well.

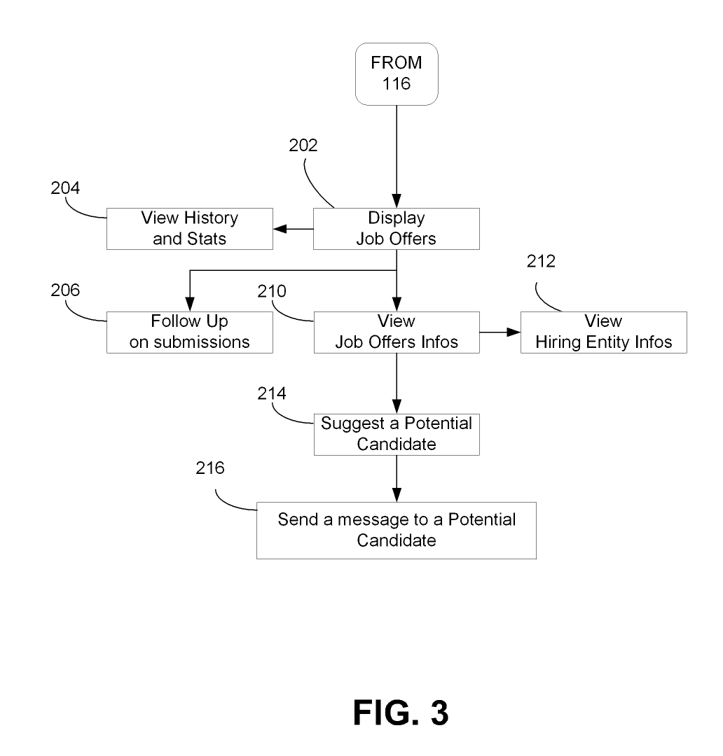

FIG. 3 is a flow diagram depicting an example of the interaction between a third-party submitter and the system 10, as executed at block 118 in FIG. 2. It starts at block 202 where, for instance, new job offer can be displayed.

At block 204, the third-party submitter may view a history of his/her past submissions as well as the related statistics.

At block 206, the third-party submitter may follow up on its past submissions, for instance if a potential candidate was rejected, selected, hired, etc.

At block 210, the third-party submitter may view job offer information and, at block 212, view hiring entity information for one or more of the job offers.

At block 214, the third-party submitter may suggest a potential candidate for a job offer by sending contact information to the system 10. For instance, this can include the name and the electronic address of that person or the like so as to allow the system 10 to send an individual electronic invitation message to the potential candidate. This electronic message can be an e-mail, an SMS or anything similar in nature. Thus, it should be noted that although the following description refers to the invitation message as being an e-mail, using other kinds of electronic messages is not excluded. If desired, only the e-mail address (or the like) can be provided to the system 10 as “contact information”. However, depending on the needs, the contact information can be more elaborated. This can include adding a personal note intended to the potential candidate and that will be displayed as part of the invitation message. It can also include notes to the hiring entity and other information, for instance if the third-party submitter can be contacted by the hiring entity for more comments, etc. The third-party submitter, however, does not represent the potential candidate and accordingly, the potential candidate will have to provide himself or herself the documents and information generally required for a full review of the candidacy.

At block 216, the individual invitation message generated by the system 10 is sent to the potential candidate. The message can include, for instance, a message ID for tracking purposes (hidden or visible) and a URL (or any other kind of electronic link) allowing the potential candidate to easily access the system 10. The invitation message is unique to the potential candidate.

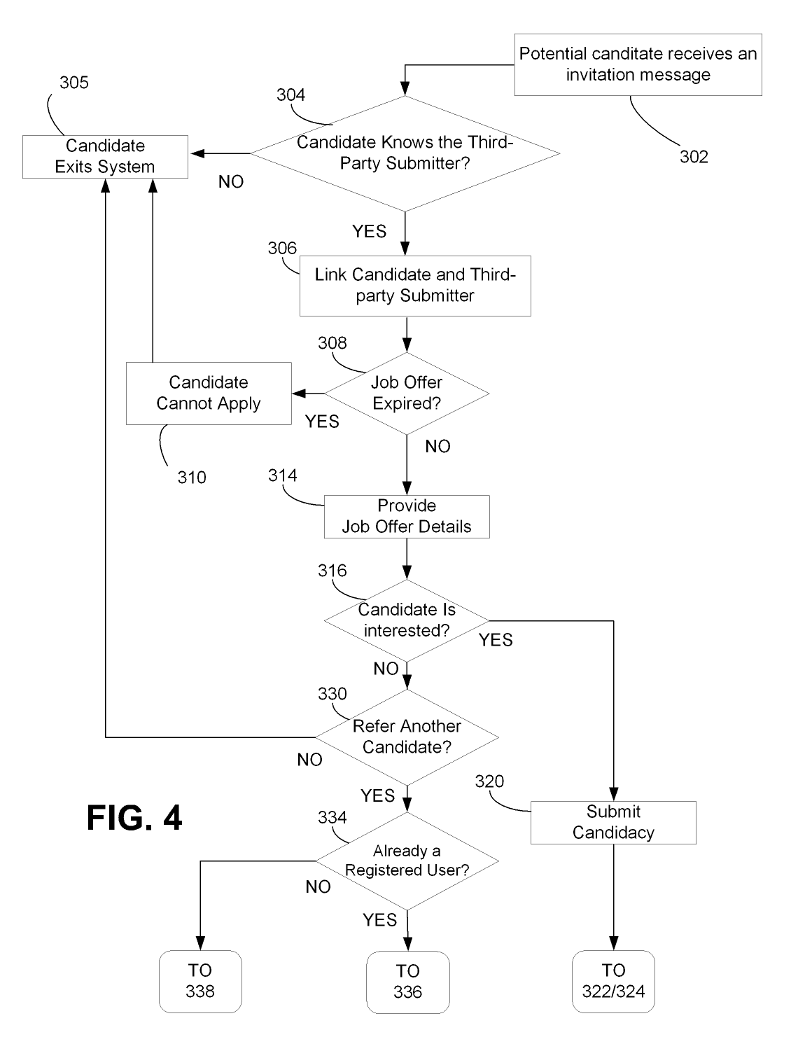

FIG. 4 is a flow diagram illustrating an example of the interaction between a potential candidate and the system 10 in response to an invitation message sent to him or her at block 216 in FIG. 3. This is referred to as the “reply” from the potential candidate.

At block 302, the potential candidate receives the invitation message and accesses the system 10 in response thereto. At that point, the potential candidate does not need to be logged in as a registered user. The hyperlink in the invitation message can contain information allowing the system 10 to immediately recognize the potential candidate and tailor the information displayed accordingly. It should be noted that a potential candidate can also reply to the invitation message without already accessing the system 10. That can be the case, for instance, of an invitation message containing an online questionnaire for which responses can be automatically sent back to the system 10 by a computing device. Another possible scenario would be to have the potential candidate click on one among a plurality of hyperlinks depending on the answer to the information being requested.

At block 304, the first information being requested from the potential candidate is to confirm that he or she is acquainted to the third-party submitter. Although other approaches are possible, this information should be requested even before the potential candidate is able to see or identify the job offer the third-party submitter believes he or she would be interested in. Otherwise, a potential candidate may decide not to answer and later ask another person else to refer him or her to the system 10 for the same job offer so that this other person has the chance of winning the reward.

If the potential candidate confirms that he or she knows the third-party submitter, the system 10 creates a relationship, at block 306, between the potential candidate and the third-party submitter who suggested him/her for the corresponding job offer. The information is then recorded in the database 16 (FIG. 1). If the potential candidate has a negative answer, then the candidate can exit the system 10 at block 305.

At block 308, the system 10 verifies if the job offer is has expired. If the job offer is expired, it proceeds to block 310 where the potential candidate is informed that he or she may not apply anymore and that the job offer has expired. The potential candidate can then exit the system 10 at block 305. Otherwise, if the job offer is still active, it goes to block 314.

At block 316, the potential candidate is able to see details about the job offer and possibly the hiring entity.

At block 318, the system 10 may ask if the potential candidate wishes to apply for the job offer. If the potential candidate does not want to apply or does not have the required skills, the system 10 proceeds to block 330. It should be noted that the potential candidate can be allowed to take the decision later, provided that the job offer has not expired yet. For instance, the hyperlink of the invitation message can remain valid for as long as the job offer is still available. The link between the potential candidate and the third-party submitter remains valid for as long as the job offer exists. The system 10 will know that the potential candidate already confirmed that he or she knows the third-party submitter so the information will not be requested again.

If the potential candidate does have the required skills and wishes to apply for the job offer, the system 10 proceeds to block 320 where the potential candidate can fill an online form with personal and professional information. The potential candidate may be asked to upload some documents, for instance, a CV and/or another relevant document such as school transcripts, certificates, etc. Following this, the system 10 goes to block 322. From that point, the potential candidate becomes a “confirmed candidate”.

At block 330, if the potential candidate answered at block 316 that he or she does not have the required skills or opted not to apply for the offered job at block 318, the system 10 may ask that person, at block 330, if he or she wants to suggest a replacement candidate for the job offer and thus share the associated reward. If the person does not want to suggest a new potential candidate, then he or she can exit the system 10 at block 305. If the person wants to suggest a replacement candidate, the system 10 verifies, at block 334, if the person is already a registered user. Alternatively, the system 10 can ask the person to answer the question.

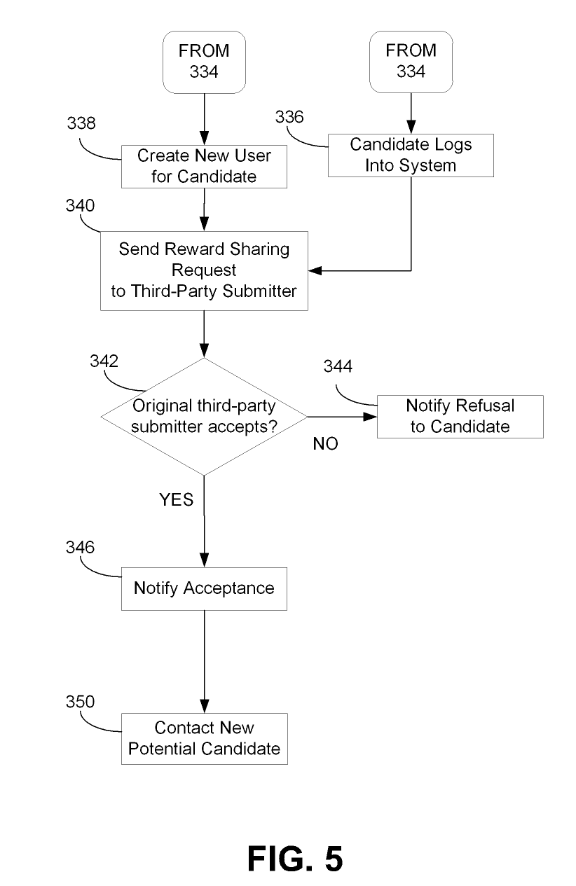

FIG. 5 is a flow diagram illustrating an example of the interaction between a potential candidate and the system when the potential candidate declines the job offer but wants to refer another potential candidate.

At block 336, the system 10 prompts the person to log into the system 10 (if not already logged in) and then proceeds to block 340. If the person is not already a registered user of the system 10, the system 10 creates, at block 338, a new user in the database 16 and starts the registration process.

At block 340, a message is sent or displayed by the system to the original third-party submitter that the former potential candidate wants to share the reward by suggesting a replacement potential candidate for the same job offer he or she was suggested for.

Then, at block 342, the original third-party submitter is asked by the system 10 whether he or she accepts to share the reward or not. If the original third-party submitter refuses to share the reward, a message is sent, at block 344, to the new third-party submitter that the offer to share the reward was declined. That person will be blocked from submitting a new potential candidate for the same job offer or, alternatively, may be allowed to submit a new potential candidate but will not receive the reward if that candidate is ultimately hired. The new third-party submitter can otherwise browse other job offers and submit contact information of potential candidates for other job offers and still set the rewards for these other job offers. He or she will not have to share the rewards for the other job offers since the link made between the original third-party submitter and the new third-party submitter was only applicable to the job offer for which an invitation message was sent in the first place.

If the original third-party submitter accepts to share the reward, then the system 10 proceeds to block 346 where a message can be sent to the subsequent third-party submitter that the offer to share the reward is accepted. Following this, the new potential candidate is associated with both third-party submitters and added to their respective follow up lists.

At block 350, an invitation message is sent by the system 10 to the new potential candidate and the system 10 will wait for a reply.

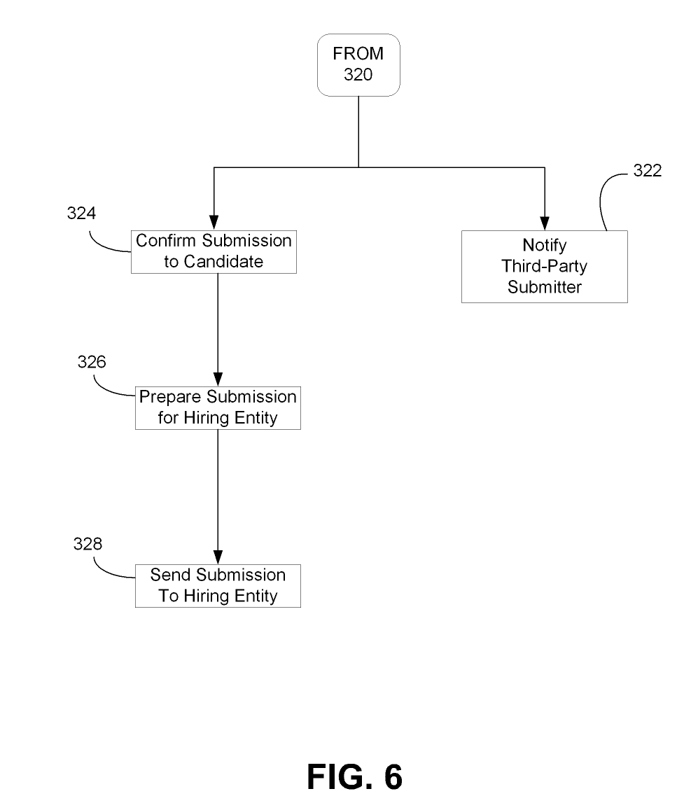

FIG. 6 is a flow diagram illustrating an example of what the system 10 can do after a candidate becomes a confirmed candidate.

At block 322, the third-party submitter which referred the potential candidate may be informed that his or her potential candidate has applied for the job offer and is now a confirmed candidate.

At block 324, the system 10 may send a confirmation message to the confirmed candidate to the effect that his/her candidacy has been successfully submitted.

At block 326, the system 10 can prepare a message for the hiring entity that created the job offer. This message may include an identification of the third-party submitter, comments about the candidate from the third-party submitter (if any), the confirmed candidate's professional information, CV and any other documents along with a rating, called hereafter a “performance indicia” of the third-party submitter. This performance indicia will be further detailed below. Following this, at block 328, the message is sent to the hiring entity to inform it that a new confirmed candidate has applied for the job offer.

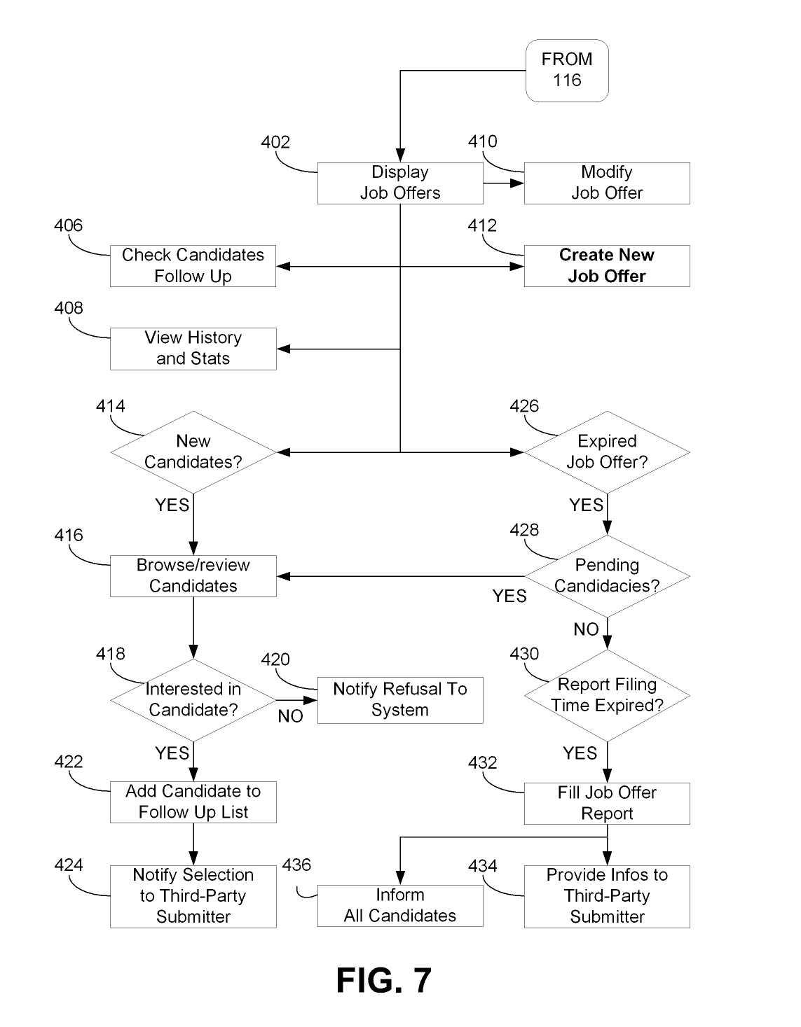

FIG. 7 is a flow diagram illustrating an example of the interaction between a hiring entity and the system 10, as executed at block 118 of FIG. 2. It starts at block 402 where the hiring entity's job offers can be displayed.

At block 406, the hiring entity may follow up on confirmed candidates.

At block 408, the hiring entity may view a history of its job offers as well as the related statistics.

At block 410, the hiring entity may modify posted job offers, for instance modifying the offered reward or push back the expiration date of posted job offers. As block 412, the hiring entity can provide the system 10 with information on a new job offer. The modified or new job offers are stored into the database 16.

The system 10 can also verify, at blocks 414 and 426, if new potential candidates have submitted their candidacy (thus became confirmed candidates) or if a job offer has expired, respectively.

If there are new confirmed candidates, the hiring entity may be allowed to browse and review, at block 416, information available on confirmed candidate.

At block 418, the hiring entity may, for each new confirmed candidate, indicate that is he or she is interested or not in this candidate. If the hiring entity is already not interested in a candidate, the system 10 proceeds to block 420 where the confirmed candidate is rejected. Depending on the configuration, a message can be sent at that point to the candidate and/or to the corresponding third-party submitter that the confirmed candidate was not selected by the hiring entity. This, however, can also be done only at the end of the selection process since it often happens that a hiring entity reconsiders the candidacy of someone rejected earlier in the selection process.

If the hiring entity is interested in the confirmed candidate, he or she is added, at block 422, to the hiring entity's follow up list and, at block 424, a message can be sent to the confirmed candidate and/or to corresponding third-party submitter that the confirmed candidate was selected by the hiring entity for the stage.

Going back to block 426, if a job offer has expired, the system 10 may proceed to block 428 where it verifies if there are any pending confirmed candidates. If so, the system 10 proceeds to block 416 where the pending confirmed candidates are presented to the hiring entity. If the time as expired, the system 10 prompts the hiring entity at block 432 to fill a report with regard to the job offer stating, amongst other things, if a confirmed candidate was hired and any other comments with respect to the process, candidacies submitted, etc. Since a reward is involved, the third-party submitters will be awaiting the outcome of the selection process and the system 10 ensures that the hiring entities proceed diligently with the selection process.

Following this, at blocks 434 and 436, information can be sent to all confirmed candidates and third-party submitters who referred candidates for the job offer as to the outcome of the selection process.

In the present concept, the system 10 calculates a performance indicia for each of the third-party submitters of the confirmed candidates and associates the performance indicia with the corresponding confirmed candidate. Each performance indicia is based on objective data recorded by the system 10 about past candidates submitted by the corresponding third-party submitter. The third-party submitter has otherwise no control on the performance indicia. The performance indicia will provide a way of filtering and/or sorting the confirmed candidates before any other information needs to be studied or verified. This way, if a very large number of confirmed candidates are competing for the same job offer, the hiring entity will be able to focus attention on the ones that have the best chances of being suitable for the available job position.

The performance indicia may be calculated using different formulas. One example is given later in the description. Whatever the actual calculation being done, one of the goals is to set apart “low quality” third-party submitters from “high quality” third-party submitters. Since a reward is involved, some people may “abuse” the system 10 by, for instance, submitting contact information of many potential candidates with which they are very distantly acquainted to. Others may have randomly submitted potential candidates that turned out to be not qualified for or interested in the available job offers. The performance indicia of such third-party submitters should reveal that behavior and associate a lower ranking to their corresponding confirmed candidates. On the other hand, some third-party submitters have a very broad network of contacts and a good judgment for connecting candidates with job offers. The performance indicia of such third-party submitter should reveal that behavior and raise the ranking of the corresponding confirmed candidates accordingly.

Since the system 10 manages the initial messages sent to the potential candidates, it can record the number of people submitted by a given third-party submitter as potential candidates and how many of these people took the time of replying to these invitation messages so as to confirm that they know that third-party submitter. The potential candidate must also, at some point, view information about the job offer and eventually confirm that he/she has is interested in that job offer. Recording such objective data yields very interesting information capable of revealing how well a third-party submitter performs with the system 10.

If desired, one can design the system 10 so that only minimal information on the confirmed candidates be required before the calculation is made. Thus, a confirmed candidate may only be asked to submit documents if he/she ultimately makes his/her way on the list of pre-selected confirmed candidates. This feature may be implemented for all job offers or may depend on the situation and what the hiring entity wants.

In use, the system 10 can generate a list including at least some of the confirmed candidates and present this list to the hiring entity. This list is at least indicative of the performance indicia of the third-party submitter associated with each of the confirmed candidates. The list may give the actual value of the performance indicia or sort the confirmed candidates by rank without giving the actual value of the performance indicia. Other ways of indicating the performance indicia on the list can be used as well. For instance, it can use symbols, such as stars “*”. From there, the hiring entity can continue the selection process, for instance by reviewing the documents associated with each confirmed candidates and/or conducting interviews with the confirmed candidates. The specific details of this selection process may vary from one situation to another and from one hiring entity to another.

Depending on the needs, a given hiring entity may prefer to only see on the list the confirmed candidates having a minimum performance indicia. If desired, that filtering can be done automatically by the system 10.

The performance indicia can be expressed as follows:

R=M+α*(p₁*W₁+p₂*W₂+ . . . +pₘ*Wₘ)−β*(q₁*z₁q₂*z₂+ . . . +qₙ*zₙ)

where:
R is the performance indicia of each third-party submitter. The value being in a given range (for instance between 0 to 10);
M is a basic value (for instance between 1 to 9);
p₁ to pₘ are positive numbers (can also be equal to zero) used as coefficients;
q₁ to qₙ are positive numbers (can also be equal to zero) used as coefficients;
* is a multiplier sign;
W₁ to Wₘ are variables calculated by the system using objective data;
z₁ to zₙ are abuse subtracters;
α is a <<rating adjuster>> that is set for each third-party submitter at the time of the calculation;
β is a <<rating adjuster>> that is set for each third-party submitter at the time of the calculation.

The value of “M” and the various coefficients are chosen so that the value of R remains within the range, namely:

$$[ M - {\sum }_{i = 0}^{n} {q}_{i} , M + {\sum }_{j = 0}^{m} {p}_{j} ]$$

The following is an example of how a performance indicia can be calculated. In this example, specific data related to past activities on a given third-party submitter are first calculated. A first set of data including five criteria are evaluated:
Activity Rate (a): a relatively high number provides an indication that the third-party submitter uses the system for sending contact information to a small number of potential candidates for each available job offer. This is viewed as positive since a low number may otherwise indicate that the third-party submitter may be submitting too many potential candidates for the same job offer.
Relational Potential (b): a relatively high value provides an indication that the third-party submitter is known by most potential candidates identified by him/her.
Networking Capacity (c): where a relatively high value provides an indication that a third-party submitter is good at identifying potential candidates interested in available job offers.
Targeting Rate (d): a relatively high value provides an indication that a third-party submitter is good at identifying high quality potential candidates for available job offers.
Placement Rate (e): where a relatively high number provides an indication that a third-party submitter is good at identifying potential candidates that are ultimately hired.

| Activity Rate | Relational Potential | Networking | Targeting | Placement |
|---|---|---|---|---|
| (a) | (b) | Capacity (c) | Rate (d) | Rate (e) |
| $a = \frac{JOT ( unique )}{JOT ( total )}$ | $b = \frac{JOC}{JOT ( total )}$ | $c = \frac{JOP}{JOC}$ | $d = \frac{JOS}{JOC}$ | $e = \frac{CPE}{JOP}$ |

| | |
|---|---|
| where: | |
| JOT(unique) | is the total number of distinct job offers for which the third-party submitter |
| | sent contact information for at least one potential candidate over a given |
| | period of time (for instance, during the last six months); |
| JOT(total) | is the total number of potential candidates for which the third-party |
| | submitter sent contact information over the given period of time; |
| JOC | is the number of potential candidates among the JOT(total) that confirmed |
| | they know the third-party submitter; |
| JOP | is the number of confirmed candidates among the JOC; |
| JOS | is the number of confirmed candidates among the JOP that were initially |
| | selected by a hiring entity for further consideration; and |
| CPE | is the number of confirmed candidates among the JOS that were hired by a |
| | hiring entity. |

A second set of data is then used to calculate a relative positioning of each of the third-party submitters with reference to other third-party submitters over a given period of time. That period of time can be the same as the one used for calculating the first set of data. However, the period of time can also be different. For instance, the results can be compared to using statistics compiled by the system for a longer or a shorter period of time. Furthermore, each or some of the calculations in the second set of data can use a different period of time compared to the others. For instance, the Relative Activity Rate (A) can use statistical data for the last three months while the Relative Placement Rate (E) can use statistical data for the last two years. Other variants are also possible as well.

| Relative | Relative | Relative | Relative | Relative |
|---|---|---|---|---|
| Activity Rate | Relational | Networking | Targeting | Placement |
| (A) | Potential (B) | Capacity (C) | Rate (D) | Rate (E) |
| $A = \frac{HRSP ( a )}{NH}$ | $B = \frac{HRSP ( b )}{NH}$ | $C = \frac{HRSP ( c )}{NH}$ | $D = \frac{HRSP ( d )}{NH}$ | $E = \frac{HRSP ( e )}{NH}$ |

| | |
|---|---|
| where: | |
| A to E | are values between 0 and 1; |
| HRSP( ) | is the number of third-party submitters having an evaluation lower than that of the |
| | third-party submitter for each one of the given criteria (“a” to “e”); and |
| NH | is the total number of active third-party submitters (i.e. third-party submitters who have |
| | proposed at least one potential candidate. |

The relative positioning data may then be used to determine rating modifiers indicative of the behavior of the third-party submitters. In the present example, the rating modifiers include abuse subtracters and rating adjusters. As their name indicates, the “abuse” subtracters are meant to lower the performance indicia of third-party submitters that do not use the system properly, either intentionally or unintentionally. It should be noted that the word “abuse” is used in a broad generic sense. The rating adjustors are used to compensate for very good results obtained by a third-party submitter with a small number of potential candidates compared to relatively good results from someone that submitted a many potential candidates. For instance, a third-party submitter may have had submitted contact information on two candidates and both were hired.

On the other hand, someone else may have submitted to contact information on twenty candidates, among which ten were ultimately hired. Both could be considered to be very performing but their performance indicia will not necessarily reflect that if it is not adjusted.

### Abuse Subtracters

| Abuse subtractor | Abuse subtractor | Abuse subtractor for |
|---|---|---|
| for Low Activity | for Relational | High Networking |
| Rate with respect to | Potential lower | Capacity with respect to |
| Networking Capacity (z₁) | than a threshold (z₂) | Targeting Rate (z₃) |
| If A < C then z₁ = | If B < T then z₂ = | If D < C then z₃ = |
| (C − A) else z₁ = 0 | (1 − B) else z₂ = 0 | (C − D) else z₃ = 0 |

where:
z₁ to z₃are values between 0 and 1;
z₁ a relatively high value is an indicator that the third-party submitter may be trying to increase its performance indicia by identifying many potential candidates for the same job offer;
z₂ a relatively high value is an indicator that the third-party submitter may be spamming (i.e. only a small number of potential candidates identified by the third-party submitter had confirmed that they know the person);
z₃ a relatively high value is indicative that the third-party submitter refers low quality potential candidates;
T is a threshold value between 0 to 1. The threshold is set in accordance with observation of spamming occurring in the system 10. For instance, T can be set to 0.4 if about 40% of the third-party submitters are believed to be “spammers” in the system 10.

### Rating Adjusters

| Performance reproducibility | |
|---|---|
| rating adjuster (α) | Quantity rating adjuster (β) |
| If JOS < aJOS then | If JOT < aJOT then |
| $α = \frac{HRSP ( JOS )}{NH ( JOS )}$ | $β = \frac{HRSP ( JOT )}{NH ( JOT )}$ |
| else α = 1 | else β = 1 |

| | |
|---|---|
| where: | |
| α and β | are values between 0 and 1; |
| aJOT | is the average number of potential candidates for which |
| | third-party submitters sent contact information to the system |
| | per third-party submitter over a given period of time; |
| aJOS | is the average number of confirmed candidates selected by a |
| | hiring entity per third-party submitter over a given period of |
| | time; |
| HRSP | is the number of third-party submitters having an evaluation |
| | lower than that of the third-party submitter being ranked; and |
| NH | is the total number of active third-party submitters over the |
| | given period of time. |

In the present example, the performance indicia can be expressed as follows:

R=5+α*(0*A+0*B+0*C+2*D+3*E)−β*(1*z₁+1*z₂+3*z₃)

Thus,

R=5+α*(2*D+3*E)−β*(z₁+z₂+3*z₃)

This yields a value of R between 0 and 10.

The selected coefficients before “D” and “E” assume that the Relative Placement Rate (E) has more weight (or importance) than the Relative Targeting Rate (D). Of course, this can differ from one situation to another and the coefficients can be adjusted accordingly. Likewise, the abuse subtractor z₃ has more weight in the equation than the other abuse subtractors. Variants are possible as well.

It should be noted that the performance rating is intended to be dynamic, meaning that it can vary constantly and it can even vary during the selection process for a given job offer. Since the confirmed candidate is linked to the third-party submitter for that job offer, any variation of the performance indicia of the corresponding third-party submitter can change the position of the confirmed candidate in the list for the pre-selection. The system 10 constantly records data in the database 16 and the calculations of the performance indicia can be recalculated either instantly or at given intervals whenever new data is gathered. Accordingly, a confirmed candidate can start with a relatively high performance indicia coming from the corresponding third-party submitter and end with a relatively low performance indicia a few days later. The contrary is also possible.

At one point, once the selection process is completed with success, the hiring entity will select the confirmed candidate believed to be the best suitable candidate for the job offer and make an offer to the chosen candidate. If desired, this notification can be made through the system 10. If the offer is accepted by the chosen candidate, then that person is considered to be hired and the third-party submitter may be rewarded. Again, if desired, the reply process from the chosen candidate can also be managed by the system 10.

It should be noted that a selection process can also be unsuccessful, meaning that, for instance, none of the confirmed candidate ultimately received an offer. The hiring entity may then, for instance, start over with a new job offer.

Upon hiring a chosen candidate, the system 10 will notify the corresponding third-party submitter that he/she has earned the reward or, if the reward is to be shared with another third-party submitter, at least a portion of the reward. This can be done in a number of ways. For instance, an email message can be sent to the third-party submitter and/or the reward itself can be sent to the third-party submitter. It is also possible to design the system 10 so as to give the third-party submitter the possibility of accumulating rewards and claiming them at a later date. It is also possible to design the system 10 to give portions of the reward at some stages of the hiring process. For instance, the third-party submitters may earn a portion of the reward as their corresponding candidate progresses from one level to another during the selection process, such as when a candidate makes it to the interview. Many other variants are possible as well.

The present detailed description and the appended figures are meant to be exemplary only, and a skilled person will recognize that variants can be made in light of a review of the present disclosure without departing from the proposed concept. For instance, the specified range of values for the performance indicia (R) is only an example and other numbers are possible as well. Likewise, the specified range of values for the basic value (M) is only an example and other numbers are possible as well. When calculating the performance indicia (R), one can select only two or more of the objective data presented and may also use other similar objective data based on the proposed approach.

### Priority Document

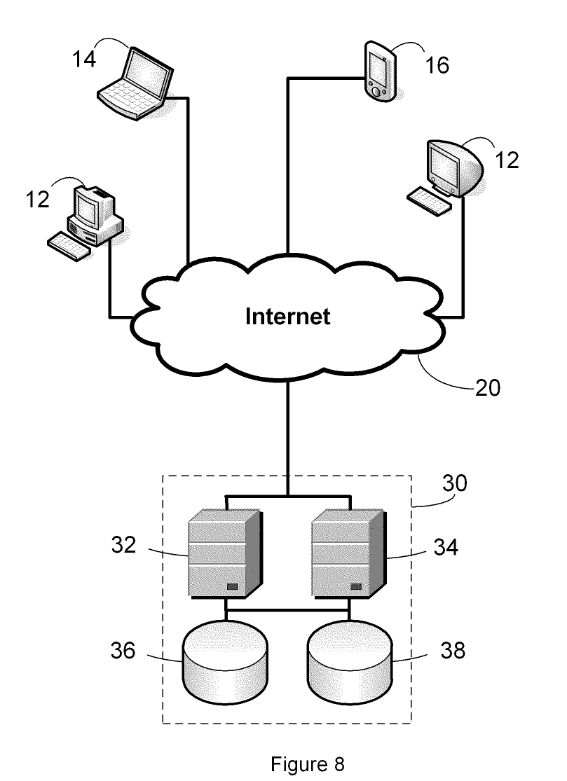

For reference propose, the following in a copy of the detailed description from the priority application. This description refers to other embodiments of the invention. Reference is made to FIGS. 8 to 13, which correspond to the original figures of the priority application. Although there is reference numbers identical to those used earlier in the present description, these reference numbers only refer to FIGS. 8 to 13. In these figures:

FIG. 8 is a schematic view of computing devices connected to the online recruitment system through a network;

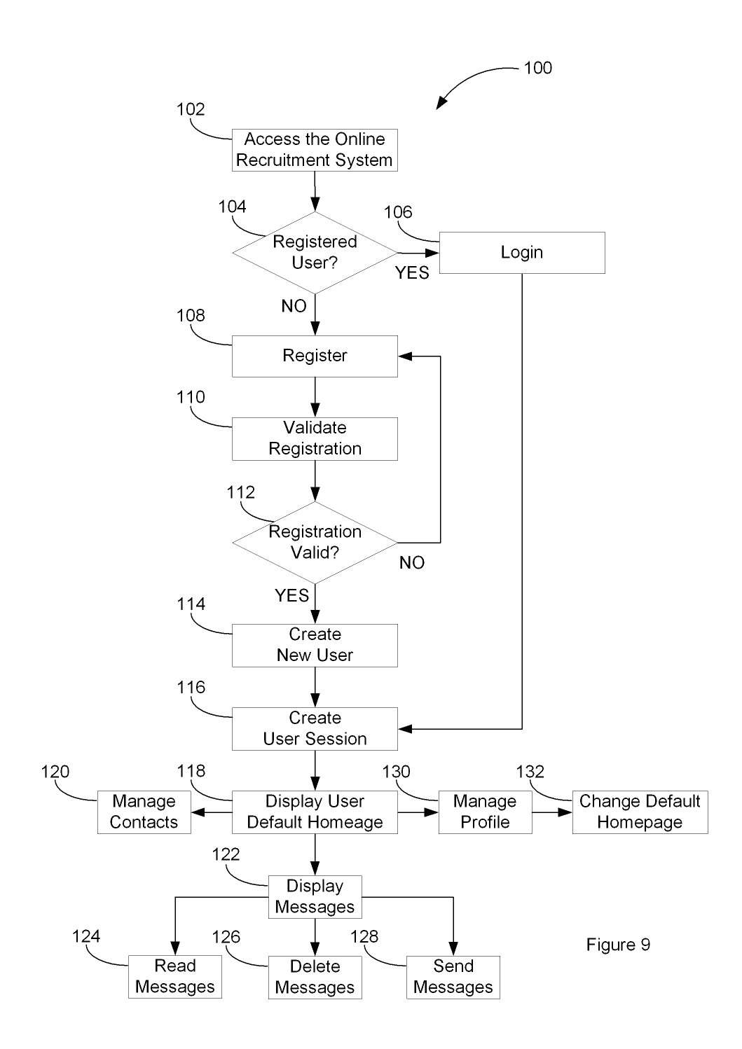

FIG. 9 is a flow diagram depicting the online recruitment process according to an illustrative embodiment of the present invention;

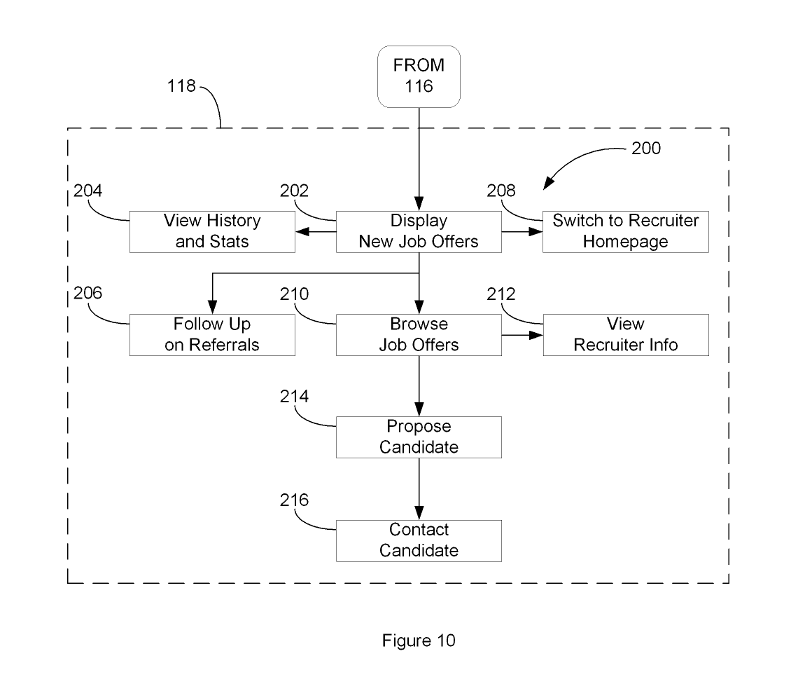

FIG. 10 is a flow diagram depicting the head hunter homepage sub-process according to an illustrative embodiment of the present invention;

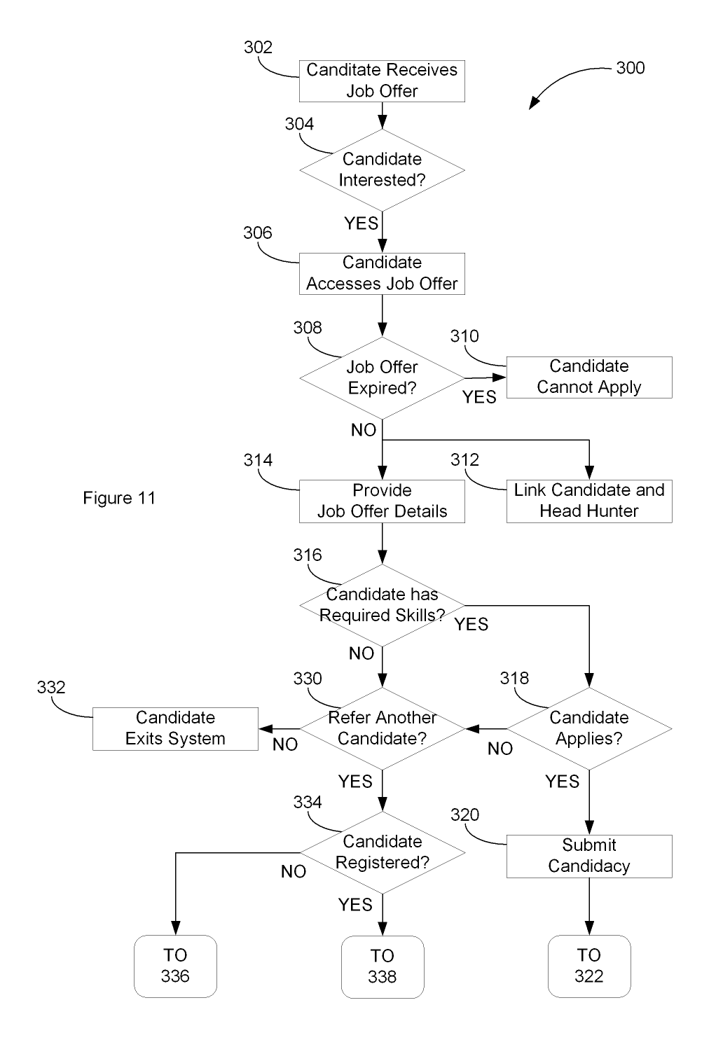

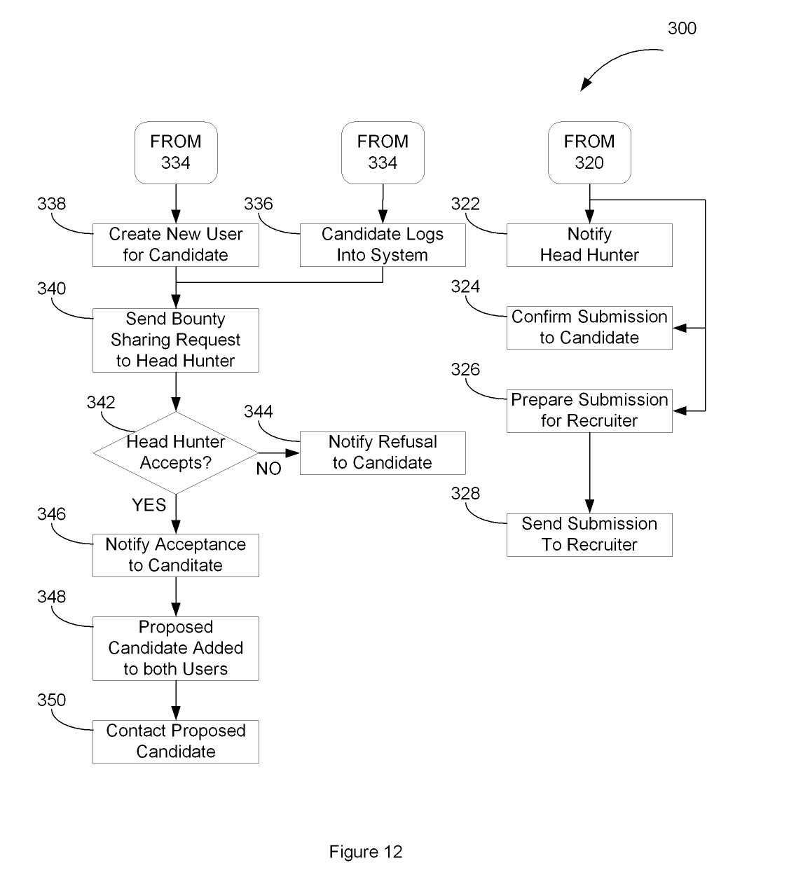

FIGS. 11 and 12 are flow diagrams depicting the candidate job offer review and candidacy submission according to an illustrative embodiment of the present invention; and

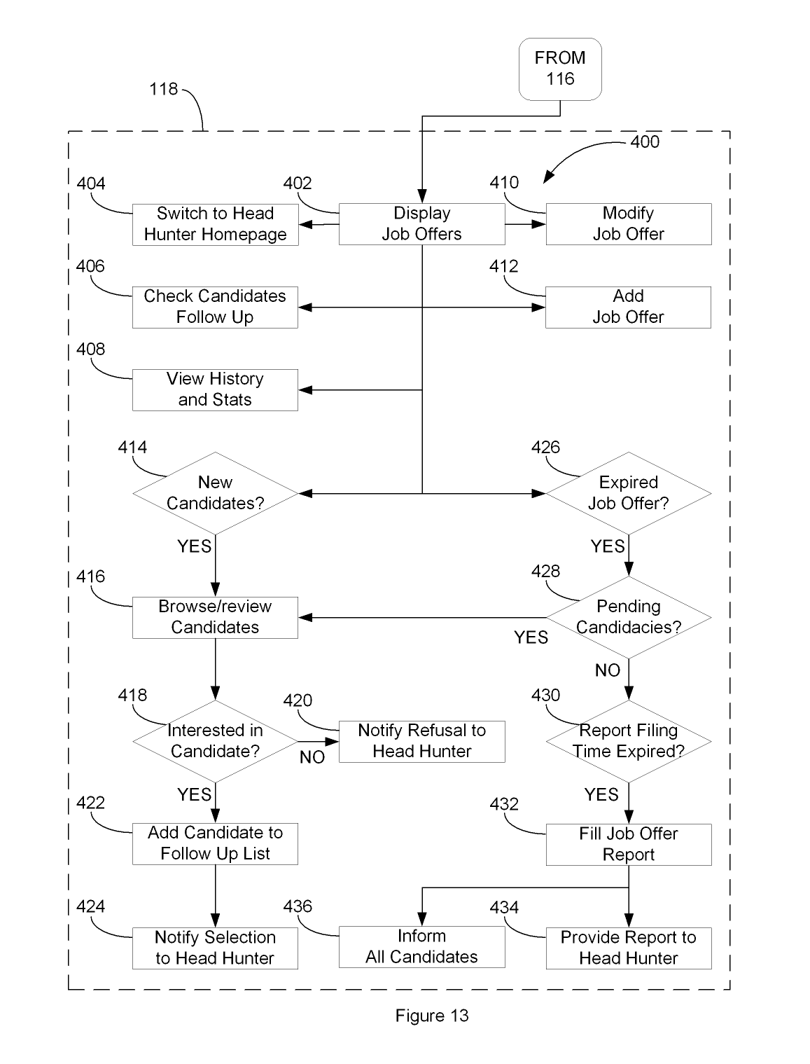

FIG. 13 is a flow diagram depicting the recruiter homepage sub-process according to an illustrative embodiment of the present invention.

Generally stated, the non-limitative illustrative embodiment of the present invention provides a method and system for recruiting potential candidates for job offers using a “head hunting” scheme, in which head hunters refer candidates for listed job offers. Considering that most employment opportunities are communicated by acquaintances, the present method and system proposes to convert common job offers into “wanted notices”, with an attached “bounty”, to encourage internet users to participate in an employee search on the internet. Accordingly, when a referred candidate is hired by a recruiter, the referring head hunter receives the attached bounty.

Another important object of the method and system is the use of a head hunter rating and evaluation process that allows recruiters to screen referred candidates according to the rating of the referring head hunters. Each head hunter's performance is measured and quantified in real-time to allow recruiters to consult and filter the source of the referred candidates. This is done via a dynamic quotation process. The results of the evaluations allow recruiters to apply a filter to the received candidatures.

Referring to FIG. 8, a user using a personal computer 12, laptop computer 14, personal assistant device 16, or any other such computing device, on which may run a user interface in the form of a communication software such as, for example, a web browser, may access the online recruitment system 30 through the web server 32 via an Internet connection 20 such as, for example, Ethernet (broadband, high-speed), wireless WiFi, cable Internet, satellite connection, cellular or satellite network, etc.

Further to the web server 32, the online recruitment system 30 includes a rating server 34, a user database 36 and a job database 38, all of which will be detailed further below. It is to be understood, however, that even though reference is made to separate servers 32 and 34 as well as separate databases 36 and 38, these may be implemented on one or more physical device and/or may be combined. It is to be further understood that the user 36 and job offer 38 databases may equally be implemented by a data structure within a computer memory.

Three general types of users will be referred to in the following disclosure, namely:

Recruiters: users registered as recruiters can publish and manage job offers in the form of “wanted notices”. They may be human resource people for a business or member of a recruitment agency mandated by the recruiting business.

Head hunters: registered users that can transmit “wanted notices” to potential candidates whose professional competence and profile's fit to the needs of the recruiter they vouch for.

Candidates: individuals responding to a “wanted notice” from a user registered as a head hunter.

It is to be understood that the listed types of users are not mutually exclusive and that a same user may at various times be of either of the described types depending on the situation.

### Online Recruitment Process

Referring now to FIG. 9, there is shown a flow diagram of an illustrative example of the online recruitment process 100 executed by the web server 32 of the online recruitment system 30. Steps of the process 100 are indicated by blocks 102 to 132.

The process 100 starts at block 102 where a user accesses the online recruitment system 30 through the web server 32.

Then, at block 104, the process 100 verifies if the user is a registered user. If so, it proceeds to block 106 where the user logs in and then proceeds to block 116, otherwise it proceeds to block 108.

At block 108, the process 100 prompts the user to register. The user enters personal information, chooses a unique username and password as well as its default homepage (i.e. the head hunter or recruiter homepage, both of which will be detailed further below).

The process 100 then validates, at block 110, the new user's information and uniqueness of username.

Then, at block 112, the process 100 verifies if the new user's registration is valid. If so, it proceeds to block 114, otherwise it returns back to block 108.

At block 114, the new user's information is stored into the user database 36 and a confirmation email is sent to the new user confirming its registration.

At block 116, the process 100 creates a new user session and, at block 118, displays the user's default homepage (i.e. the head hunter or recruiter homepage, both of which will be detailed further below). From hereon, the user may also manage its contacts at block 120, display messages at block 122 and manage its profile at block 130. Further to displaying its messages, the user may also read messages at block 124, delete messages at block 126 and send messages at block 128. Furthermore, when managing its profile at block 103, the user may also change its default homepage at block 132.

It is to be understood that additional functionalities may be provided as well.

### Head Hunter Homepage Sub-Process

Referring to FIG. 10, there is shown a flow diagram of an illustrative example of the head hunter homepage sub-process 200 executed at block 118 of FIG. 9. Steps of the process 200 are indicated by blocks 202 to 216.

The process 200 starts at block 202 where all new job offers are displayed.

At block 204, the head hunter may view a history of its referrals as well as statistics.

At block 206, the head hunter may follow up on its referrals (i.e. if the candidate was rejected, selected, hired, etc.).

At block 208, the head hunter may switch to the recruiter homepage, which will be detailed further below.

At block 210, the head hunter may browse the new job offers (as well as previous job offers) and, at block 212, view recruiter information for one or more of the job offers. The recruiter information may include the recruiter profile, statistics and ratings.

At block 214, the head hunter may propose a candidate for a job offer following which, at block 216, an email is sent to the candidate with a job offer ID for tracking purposes and a URL to view the details of the job offer.

### Candidate Candidacy Sub-Process

Referring to FIGS. 11 and 12, there is shown a flow diagram of an illustrative example of the candidate job offer review and candidacy submission sub-process 300 performed once a candidate is contacted at block 216 of FIG. 10. Steps of the process 300 are indicated by blocks 302 to 350.

The process 300 starts at block 302 where the candidate receives an email with a proposed job offer and a URL to the job offer on the online recruitment system 30.

At block 304, the candidate reviews the job offer and if interested clicks, at block 306, on the provided link (i.e. URL) in order to access the job offer on the online recruitment system 30.

At block 308, the sub-process 300 verifies if the job offer has expired. If so, it proceeds to block 310 where the candidate is informed that it may not apply anymore and that the job offer has expired. If not, it proceeds to blocks 312 and 314. At block 312, the sub-process 300 creates a relationship between the candidate and the head hunter who proposed the candidate for this job offer. At block 314, the candidate is provided with the detailed information about the job offer and the recruiter.

Then at block 316, the sub-process 300 prompts the candidate if it has the required skills for the offered job. In an alternative embodiment this step may comprise some further automatic sub-processes verifying a profile of the candidate's, its Curriculum Vitae (CV), prompt to fill a form, etc.

If the candidate has the required skills the sub-process 300 prompts it, at block 318, if it wishes to apply for the job offered job. If the candidate does not want to apply or does not have the required skills, the sub-process 300 proceeds to block 330.

If the candidate does have the required skills and wishes to apply for the offered job, the sub-process 300 proceeds to block 320 where the candidate fills an online form with its professional information and attaches a CV (and another required information or document, for example scanned school transcripts, certificates, etc.). Following this, the sub-process 300 proceeds to blocks 322, 324 and 326.

At block 322, the head hunter which referred the candidate is informed that the candidate has applied for the offered job.

At block 324, the sub-process sends a confirmation email to the candidate to the effect that its candidacy has been submitted.

At block 326, the sub-process 300 prepares a message for the recruiter who posted the job offer. This message includes the referring head hunter's presentation of the candidate, the candidate' professional information, CV and any other documents along with a rating of the head hunter.

The head hunter rating will be further detailed below. Following this, at block 328, the message is sent to the recruiter to inform it that a new candidate has applied for the job offer.

At block 330, if the candidate did not have the required skills at block 316 or opted not to apply for the offered job at block 318, the sub-process prompts the candidate, at block 330 if it wants to suggest a replacement candidate for the offered job and thus share the bounty attached to the job offer. If the candidate does not want to suggest a replacement candidate, then it exits the online recruitment system at block 332. If the candidate wants to suggest a replacement candidate, the sub-process 300 verifies, at block 334, if the candidate is registered in the user database 36. If so, at block 336, it prompts the candidate to log into the online recruitment system 30 and then proceeds to block 340. If the candidate is not registered in the online recruitment system 30, the sub-process 300 creates, at block 338, a new user in the user database 36 through the usual registration process.

At block 340, a message is sent to the referring head hunter that the candidate wants to share the offered bounty by suggesting a replacement candidate.

Then, at block 342, the heat hunter is prompted by the sub-process 300 if it accepts to share the bounty or not. If the head hunter refuses to share the bounty a message is sent, at block 344, to the candidate that its offer to share the bounty was refused. If the head hunter accepts to share the bounty, then the sub-process 300 proceeds to block 346 where a message is sent to the candidate, now a new head hunter, that its offer to share the bounty has been accepted.

Following this, at block 348, the proposed replacement candidate is linked to both head hunters and added to their respective follow up lists.

Finally, at block 350, an email is sent to the proposed replacement candidate with a job offer ID for tracking purposes and a URL to view the details of the job offer.

### Recruiter Homepage Sub-Process

Referring to FIG. 13, there is shown a flow diagram of an illustrative example of the recruiter homepage sub-process 400 executed at block 118 of FIG. 9. Steps of the process 400 are indicated by blocks 402 to 436.

The process 400 starts at block 402 where the recruiter's job offers are displayed.

At block 404, the recruiter may switch to the head hunter homepage.

At block 406, the recruiter may follow up on its received candidacies.

At block 408, the recruiter may view a history of its job offers as well as statistics.

At block 410, the recruiter may modify posted job offers (e.g. modifying the offered bounty) or, at block 412, post a new job offer. The modified or new job offers are then stored into the job database 38.

The sub-process 400 also verifies, at blocks 414 and 426, if new candidates have submitted their candidacy or if a job offer has expired, respectively.

At block 414, if there are new candidates who submitted their candidacy, the recruiter may browse and review, at block 416, the candidate information, CV, referring head hunter information, etc. for each submitted candidacies. The recruiter may filter the submitted candidacies using the ratings of the referring head hunters. The head hunter rating will be further detailed below.

At block 418, the recruiter may, for each newly submitted candidacy, indicate that is it interested or not in the candidate. If the recruiter is not interested in a candidate, the sub-process 400 proceeds to block 420 where the candidacy is removed from the online recruitment system 30 and a message is sent to the referring head hunter that its candidate was not selected by the recruiter. If the recruiter is interested in the candidate, the candidate is added, at block 422, to the recruiter's follow up list and, at block 424, a message is sent to the referring head hunter that the candidate was selected by the recruiter.

Going back to block 426, if a job offer has expired, the sub-process 400 proceeds to block 428 where it verifies if there are any pending candidacies. If so, the sub-process 400 proceeds to block 416 where the pending candidacies are presented to the recruiter. If not, at block 430, the sub-process 400 verifies if the time for the filing of the job report as expired.

If the time as expired, the sub-process 400 prompts the recruiter to fill a report with regard to the job offer stating, amongst other things, if a candidate was hired and any other comments with respect to the process, candidacies submitted, etc.

Following this, the report is sent to the head hunters who referred candidates for the job offer, at block 434, and sends an email to all candidates as to the outcome of the job offer.

### Dynamic Head Hunter Ranking

As mentioned at block 326 of FIG. 11 and block 416 of FIG. 13, the performance of each active head hunter is continuously evaluated by the online recruitment system 30. This evaluation process results in a rating being attributed to each active head hunter, the objective of this rating is to allow recruiters to select candidates taking into consideration the referring head hunter's historic.

Accordingly, there will now be described a head hunter rating and evaluation process according to an illustrative embodiment of the present invention.

First, the evaluation process takes into account five evaluation criteria.

### Head Hunter Evaluation Criteria

| Activity Rate | Relational | Networking | Targeting | Placement |
|---|---|---|---|---|
| (a) | Potential (b) | Capacity (c) | Rate (d) | Rate (e) |
| $a = \frac{JOT ( unique )}{JOTtotal}$ | $b = \frac{JOC ( confirm )}{JOTtotal}$ | $c = \frac{JOP}{JOC}$ | $d = \frac{JOS}{JOP}$ | $e = \frac{CPE}{JOP}$ |

| | |
|---|---|
| where | |
| JOT | is the number of job offers transmitted by a head hunter; |
| JOC | is the number of job offers consulted by a candidate; |
| JOP | is the number of job offers for which a candidate postulated; |
| JOS | is the number of candidacy selected by a recruiter; and |
| CPE | is the number of candidate placement in an enterprise. |

The evaluation criteria are then used to compute positioning measurements.

### Positioning Measurements

The positioning measurements are measures of the rank of a specific head hunter with respect to the other head hunters for each evaluation criteria.

| Activity | Relational | Networking | Targeting | Placement |
|---|---|---|---|---|
| Rate (A) | Potential (B) | Capacity (C) | Rate (D) | Rate (E) |
| $A = \frac{HRSP ( a )}{NH}$ | $B = \frac{HRSP ( b )}{NH}$ | $C = \frac{HRSP ( c )}{NH}$ | $D = \frac{HRSP ( d )}{NH}$ | $E = \frac{HRSP ( e )}{NH}$ |

| | |
|---|---|
| where | |
| A to E | are values between 0 and 1; |
| HRSP | is the number of head hunters having an evaluation lower than that of the head hunter |
| | being ranked; and |
| NH | is the number of active head hunters (i.e. head hunters who have proposed a candidacy |
| | in a given period of time, for example in the last six months). |

The positioning measurements may then be combined to determine rating modifiers indicative of the behavior of the head hunter.

### Rating Subtracters

| Low Activity Rate | Relational Potential | High Networking Capacity |
|---|---|---|
| with respect to | lower than a | with respect to Targeting |
| Networking Capacity | threshold of 0.4 | Rate |
| If A < C then z₁ = | If B < 0.4 then z₂ = | If D < C then |
| (C − A) else z₁ = 0 | (1 − B) else z₂ = 0 | z₃ = (C − D) else z₃ = 0 |

where
z₁ to z₃ are values between 0 and 1;
z₁ is an indicator that a head hunter may be trying to increase its rank by having many candidates postulate for the same job offer;
z₂ is an indicator that the head hunter may be spamming (i.e. few candidates click on its links); and
z₃ is an indicator that the head hunter refers low quality candidates.

### Rating Multipliers

| Performance reproducibility | Quantity |
|---|---|
| If JOS < aJOS then | If JOT < aJOT then |
| $α = \frac{sHRSP ( JOS )}{sNH ( JOS )}$ | $β = \frac{sHRSP ( JOT )}{sNH ( JOT )}$ |
| else α = 1 | else β = 1 |

| | |
|---|---|
| where | |
| α and β | are values between 0 and 1; |
| aJOT | is the number of job offers transmitted by a head hunter; |
| aJOS | is the number of candidacy selected by a recruiter; |
| sHRSP | is the number of head hunters having an evaluation lower than |
| | that of the head hunter being ranked; and |
| sNH | is the number of active head hunters (i.e. head hunters who have |
| | proposed a candidacy in a given period of time, for example in the |
| | last six months). |

Thus, the rating of a head hunter may be computed as follows:

R=┌5+α*(2*D+3*E)−β*(z₁+z₂+3*z₃)┐, Equation 1

which returns an integer R between 0 and 10.

It is to be understood that this rating and evaluation process may be modified or that alternative rating and evaluation processes may be substituted.

1. An on-line recruitment system including:
a processor;
a memory operatively connected to the processor, the memory storing a program for directing the processor to:
receive information concerning a job offer from an hiring entity, the job offer including a reward;
receive contact information from third-party submitters concerning potential candidates that may be interested and qualified for filling the job offer;
send individual electronic invitation messages to the potential candidates about the job offer and the corresponding third-party submitter that referred them, the invitation messages being sent to each potential candidate using the contact information received from the corresponding third-party submitter;
receive a confirmation from the potential candidate that he/she is acquainted with the corresponding third-party submitter;
upon receiving the confirmation from the potential candidate that he/she is acquainted with the corresponding third-party submitter, present information about the job offer to the potential candidate;
upon receiving an indication from at least one of the potential candidates that he/she would like to apply for the job offer, upgrade the potential candidate to a confirmed candidate;
calculate a performance indicia for each of the third-party submitters of the confirmed candidates and associate the performance indicia with the corresponding confirmed candidate, each performance indicia being based on objective data recorded by the system about past candidates submitted by the corresponding third-party submitter; and
upon hiring one of the confirmed candidates, notify the corresponding third-party submitter that he/she has earned at least a portion of the reward.

2. The system as defined in claim 1, characterized in that the program further directs the processor to:
upon receiving a confirmation from the potential candidate that he/she is acquainted with the corresponding third-party submitter, associate the third-party submitter and the potential candidate for as long as the job offer is active.

3. The system as defined in claim 2, characterized in that the program directs the processor to prevent a potential candidate already associated with a third-party candidate for a given job offer from being referred by someone else for the same job offer.

4. The system as defined in any one of claims 1 to 3, characterized in that the program further directs the processor to:
once the performance indicia are calculated, generate a list including at least some of the confirmed candidates, the list being at least indicative of the performance indicia of the third-party submitter associated with each of the confirmed candidates; and then present the list to the hiring entity.

5. The system as defined in any one of claims 1 to 4, characterized in that the program further directs the processor to:
upon receiving an indication from at least one of the potential candidates that he/she would not like to apply for the job offer, invite the potential candidate to become a third-party submitter for the same job offer; and
upon receiving a confirmation from one of the former potential candidates that he/she would like to become a third-party submitter for the same job offer, ask the corresponding third-party submitter if sharing the reward with the former potential candidate would be acceptable if a potential candidate submitted from that person is ever hired.

6. The system as defined in any one of claims 1 to 5, characterized in that the performance indicia is calculated using at least two of the following objective data:
Activity Rate (a), where a relatively high number provides an indication that a third-party submitter uses the system for sending contact information to a small number of potential candidates for each available job offer;
Relational Potential (b), where a relatively high value provides an indication that a third-party submitter is known by most potential candidates identified by him/her;
Networking Capacity (c), where a relatively high value provides an indication that a third-party submitter is good at identifying potential candidates interested in available job offers;
Targeting Rate (d), where a relatively high value provides an indication that a third-party submitter is good at identifying high quality potential candidates for available job offers;
Placement Rate (e), where a relatively high number provides an indication that a third-party submitter is good at identifying potential candidates that are ultimately hired.

7. The system as defined in claim 6, characterized in that the performance indicia is expressed as R=M+α*(p₁*W₁+p₂*W₂+ . . . +pₘ*Wₘ)−β*(q₁*z₁+q₂*z₂+ . . . +qₙ*zₙ), where:
R is the performance indicia of each third-party submitter,
M is a basic value,
p₁ to pₘ are positive numbers used as coefficients;
q₁ to qₙ are positive numbers used as coefficients;
* is a multiplier sign;
W₁ to Wₘ are variables calculated by the system using at least two of the objective data (a) to (e);
z₁ to zₙ are abuse subtracters;
α is a first rating adjuster that is set for each third-party submitter at the time of the calculation;
β is a second rating adjuster that is set for each third-party submitter at the time of the calculation.

8. The system as defined in claim 7, characterized in that the at least two objective data (a) to (e) used for calculating the W₁ to Wₘ variables are calculated as follows:

| Activity Rate | Relational | Networking | Targeting | Placement |
|---|---|---|---|---|
| (a) | Potential (b) | Capacity (c) | Rate (d) | Rate (e) |
| $a = \frac{JOT ( unique )}{JOT ( total )}$ | $b = \frac{JOC}{JOT ( total )}$ | $c = \frac{JOP}{JOC}$ | $d = \frac{JOS}{JOC}$ | $e = \frac{CPE}{JOP}$ |
| | |
|---|---|
| where: | |
| JOT(unique) | is the total number of distinct job offers for which a third-party submitter |
| | sent contact information for at least one potential candidate over a first given |
| | period of time; |
| JOT(total) | is the total number of potential candidates for which a third-party submitter |
| | sent contact information over the given period of time; |
| JOC | is the number of potential candidates among the JOT(total) that confirmed |
| | they know the third-party submitter; |
| JOP | is the number of confirmed candidates among the JOC; |
| JOS | is the number of confirmed candidates among the JOP that were initially |
| | selected by a hiring entity for further consideration; and |
| CPE | is the number of confirmed candidates among the JOS that were hired by a |
| | hiring entity. |

9. The system as defined in claim 8, characterized in that values of the variables W₁ to Wₘ are calculated using a relative comparison of the at least two objective data with corresponding objective data from other third-party submitters, the respective calculations being done as follows:

| Relative | Relative | Relative | Relative | Relative |
|---|---|---|---|---|
| Activity Rate | Relational | Networking | Targeting | Placement |
| (A) | Potential (B) | Capacity (C) | Rate (D) | Rate (E) |
| $A = \frac{HRSP ( a )}{NH}$ | $B = \frac{HRSP ( b )}{NH}$ | $C = \frac{HRSP ( e )}{NH}$ | $D = \frac{HRSP ( d )}{NH}$ | $E = \frac{HRSP ( e )}{NH}$ |
| | |
|---|---|
| where: | |
| A to E | are values between 0 and 1; |
| HRSP( ) | is the number of third-party submitters having an evaluation lower than |
| | that of the third-party submitter for each one of the given criteria |
| | (“a” to “e”); and |
| NH | is the total number of active third-party submitters. |

10. The system as defined in claim 9, characterized in that the abuse subtracters z₁ to zₙ include three abuse subtracters z₁ to z₃ calculated as follows:

| Abuse subtractor | Abuse subtractor | Abuse subtractor for |
|---|---|---|
| for Low Activity | for Relational | High Networking |
| Rate with respect to | Potential lower | Capacity with respect to |
| Networking Capacity (z₁) | than a threshold (z₂) | Targeting Rate (z₃) |
| If A < C then z₁ = | If B < T then z₂ = | If D < C then z₃ = |
| (C − A) | (1 − B) | (C − D) |
| else z₁ = 0 | else z₂ = 0 | else z₃ = 0 |

where:
z₁ to z₃ are values between 0 and 1;
T is a threshold value between 0 to 1.

11. The system as defined in any one of claims 7 to 10, characterized in that the values of α and β are calculated as follows:

| Performance reproducibility | |
|---|---|
| rating adjuster (α) | Quantity rating adjuster (β) |
| If JOS < aJOS then | If JOT < aJOT then |
| $α = \frac{HRSP ( JOS )}{NH ( JOS )}$ | $β = \frac{HRSP ( JOT )}{NH ( JOT )}$ |
| else α = 1 | else β = 1 |
| | |
|---|---|
| where: | |
| α and β | are values between 0 and 1; |
| aJOT | is the average number of potential candidates for which third-party |
| | submitters sent contact information to the system per third-party |
| | submitter over time; |
| aJOS | is the average number of confirmed candidates selected by a hiring |
| | entity per third-party submitter over time; |
| HRSP | is the number of third-party submitters having an evaluation lower |
| | than that of the third-party submitter being ranked; and |
| NH | is the total number of active third-party submitters over the given |
| | period of time. |

12. The system as defined in any one of claims 1 to 11, characterized in that communications of the hiring entities, the third-party submitters and the candidates with the system is made over a data network, for instance the Internet.

13. The system as defined in claim 12, characterized in that the hiring entities, the third-party submitters and the candidates interact with the system using a plurality of computing devices.

14. The system as defined in claim 13, characterized in that some of the computing devices include portable devices.

15. The system as defined in any one of claims 1 to 14, characterized in that the individual electronic invitation messages sent by the system include at least one among an e-mail and a SMS.

16. The system as defined in any one of claims 1 to 15, characterized in that the system generates web pages to display information to users.

17. The system as defined in any one of claims 1 to 16, characterized in that the processor and the memory are part of at least one server linked to at least one database.

18. The system as defined in any one of claims 1 to 17, characterized in that the performance indicia is dynamically calculated for at least as long as the job offer is active.

19. A method for recruiting employees, the method including:
receiving information concerning a job offer from a hiring entity the job offer including a reward;
receiving contact information from third-party submitters concerning potential candidates that may be interested and qualified for filling the job offer;
sending individual messages to the potential candidates about the job offer and the corresponding third-party submitter that referred them, the messages being sent to each potential candidate using the contact information received from the corresponding third-party submitter and including at least a request to confirm that the potential candidate is acquainted with the corresponding third-party submitter;
receiving a confirmation from the potential candidate that he/she is acquainted with the corresponding third-party submitter;
upon receiving the confirmation from the potential candidate that he/she is acquainted with the corresponding third-party submitter, presenting information about the job offer to the potential candidate;
upon receiving a confirmation from at least one of the potential candidates that he/she would like to apply for the job offer, upgrading the potential candidate to a confirmed candidate;
calculating a performance indicia for each of the third-party submitters of the confirmed candidates and associating the performance indicia with the corresponding confirmed candidate, each performance indicia being based on objective data recorded by the system about past candidates submitted by the corresponding third-party submitter and
upon hiring one of the confirmed candidates, notifying the corresponding third-party submitter that he/she has earned at least a portion of the reward.

20. The method as defined in claim 19, characterized in that the method includes:
upon receiving a confirmation from the potential candidate that he/she is acquainted with the corresponding third-party submitter, associating the third-party submitter and the potential candidate for as long as the job offer is active.

21. The method as defined in claim 20, characterized in that the method includes preventing a potential candidate already associated with a third-party candidate for a given job offer from being referred by someone else for the same job offer.

22. The method as defined in any one of claims 19 to 21, characterized in that it further includes:
after calculating the performance indicia, generating a list including at least some of the confirmed candidates, the list being at least indicative of the performance indicia of the third-party submitter associated with each of the confirmed candidates; and then presenting the list to the hiring entity.

23. The method as defined in any one of claims 19 to 22, characterized in that the performance indicia is calculated using at least two of the following objective data:
Activity Rate (a), where a relatively high number provides an indication that a third-party submitter uses the system for sending contact information to a small number of potential candidates for each available job offer;
Relational Potential (b), where a relatively high value provides an indication that a third-party submitter is known by most potential candidates identified by him/her;
Networking Capacity (c), where a relatively high value provides an indication that a third-party submitter is good at identifying potential candidates interested in available job offers;
Targeting Rate (d), where a relatively high value provides an indication that a third-party submitter is good at identifying high quality potential candidates for available job offers;
Placement Rate (e), where a relatively high number provides an indication that a third-party submitter is good at identifying potential candidates that are ultimately hired.

24. The method as defined in claim 23, characterized in that the performance indicia is expressed as R=M+α*(p₁*W₁+p₂*W₂+ . . . +pₘ*Wₘ)−β*(q₁*z₁+q₂*z₂+ . . . +qₙ*zₙ), where:
R is the performance indicia of each third-party submitter,
M is a basic value,
p₁ to pₘ are positive numbers used as coefficients;
q₁ to qₙ are positive numbers used as coefficients;
* is a multiplier sign;
W₁ to Wₘ are variables calculated by the system using at least two of the objective data (a) to (e);
z₁ to zₙ are abuse subtracters;
α is a first rating adjuster that is set for each third-party submitter at the time of the calculation;
β is a second rating adjuster that is set for each third-party submitter at the time of the calculation.

25. The method as defined in claim 24, characterized in that the at least two objective data (a) to (e) used for calculating the W₁ to Wₘ variables are calculated as follows:

| Activity Rate | Relational | Networking | Targeting | Placement |
|---|---|---|---|---|
| (a) | Potential (b) | Capacity (c) | Rate (d) | Rate (e) |
| $a = \frac{JOT ( unique )}{JOT ( total )}$ | $b = \frac{JOC}{JOT ( total )}$ | $c = \frac{JOP}{JOC}$ | $d = \frac{JOS}{JOC}$ | $e = \frac{CPE}{JOP}$ |
| | |
|---|---|
| where: | |
| JOT(unique) | is the total number of distinct job offers for which a third-party submitter |
| | sent contact information for at least one potential candidate over a first given |
| | period of time; |
| JOT(total) | is the total number of potential candidates for which a third-party submitter |
| | sent contact information over the given period of time; |
| JOC | is the number of potential candidates among the JOT(total) that confirmed |
| | they know the third-party submitter; |
| JOP | is the number of confirmed candidates among the JOC; |
| JOS | is the number of confirmed candidates among the JOP that were initially |
| | selected by a hiring entity for further consideration; and |
| CPE | is the number of confirmed candidates among the JOS that were hired by a |
| | hiring entity. |

26. The method as defined in claim 25, characterized in that values of the variables W₁ to Wₘ are calculated using a relative comparison of the at least two objective data with corresponding objective data from other third-party submitters, the respective calculations being done as follows:

| Relative | Relative | Relative | Relative | Relative |
|---|---|---|---|---|
| Activity Rate | Relational | Networking | Targeting | Placement |
| (A) | Potential (B) | Capacity (C) | Rate (D) | Rate (E) |
| $A = \frac{HRSP ( a )}{NH}$ | $B = \frac{HRSP ( b )}{NH}$ | $C = \frac{HRSP ( c )}{NH}$ | $D = \frac{HRSP ( d )}{NH}$ | $E = \frac{HRSP ( e )}{NH}$ |
| | |
|---|---|
| where: | |
| A to E | are values between 0 and 1; |
| HRSP( ) | is the number of third-party submitters having an evaluation lower than that of the |
| | third-party submitter for each one of the given criteria (“a” to “e”); and |
| NH | is the total number of active third-party submitters. |

27. The method as defined in claim 26, characterized in that the abuse subtracters z₁ to zₙ include three abuse subtracters z₁ to z₃ calculated as follows:

| Abuse subtractor | Abuse subtractor | Abuse subtractor for |
|---|---|---|
| for Low Activity | for Relational | High Networking |
| Rate with respect to | Potential lower | Capacity with respect to |
| Networking Capacity (z₁) | than a threshold (z₂) | Targeting Rate (z₃) |
| If A < C then z₁ = | If B < T then z₂ = | If D < C then z₃ = |
| (C − A) | (1 − B) | (C − D) |
| else z₁ = 0 | else z₂ = 0 | else z₃ = 0 |

where:
z₁ to z₃ are values between 0 and 1;
T is a threshold value between 0 to 1.

28. The method as defined in any one of claims 19 to 27, characterized in that the values of α and β are calculated as follows:

| Performance reproducibility | |
|---|---|
| rating adjuster (α) | Quantity rating adjuster (β) |
| If JOS < aJOS then | If JOT < aJOT then |
| $α = \frac{HRSP ( JOS )}{NH ( JOS )}$ | $β = \frac{HRSP ( JOT )}{NH ( JOT )}$ |
| else α = 1 | else β = 1 |
| | |
|---|---|
| where: | |
| α and β | are values between 0 and 1; |
| aJOT | is the average number of potential candidates for which third-party |
| | submitters sent contact information to the system per third-party |
| | submitter over time; |
| aJOS | is the average number of confirmed candidates selected by a hiring |
| | entity per third-party submitter over time; |
| HRSP | is the number of third-party submitters having an evaluation lower |
| | than that of the third-party submitter being ranked; and |
| NH | is the total number of active third-party submitters over the given |
| | period of time. |

29. The method as defined in any one of claims 19 to 28, characterized in that the individual electronic invitation messages include at least one among an e-mail and a SMS.

30. The method as defined in any one of claims 19 to 29, characterized in that the information to users are displayed as web pages.

31. The method as defined in any one of claims 19 to 30, characterized in that at least a portion of the method occurs in a processor and a memory that are part of at least one server linked to at least one database.

32. The method as defined in any one of claims 19 to 31, characterized in that the performance indicia is dynamically calculated for at least as long as the job offer is active.
